(19) United States
(12) Patent Application Publication
(10) Pub. No.: US 2013/0191255 A1
(43) Pub. Date: Jul. 25, 2013

(54) Method for Purchasing or Generating Construction Liens and Notice Documents from Calculated Deadlines and Smart Recognition of Deadline Satisfaction Via a Communication Network

(71) Applicant: Scott Gerard Wolfe, New Orleans, LA (US)

(72) Inventor: Scott Gerard Wolfe, New Orleans, LA (US)

(21) Appl. No.: 13/490,781

(22) Filed: Jun. 7, 2012

Related U.S. Application Data
(60) Provisional application No. 61/502,486, filed on Jun. 29, 2011.

(51) Int. Cl. G06Q 40/00

(52) U.S. Cl. CPC G06Q 40/10
USPC 705/30

(57) ABSTRACT

This invention provides a Method and System for Ordering Mechanic's Lien and Notice Documents over the internet, mobile applications, or mobile communications network utilizing database records managed by a backend Product Input System that relates products/services to states, user role, hired-by role, and project type. The invention calculates Notice and Lien requirements, determines the applicable related products, and suggests those products to the user to order. The calculated deadlines are rendered smart and usable by allowing the user to satisfy those deadlines by ordering a specifically applicable product and/or service as suggested by the invention. Further, the system is able to determine when a deadline has been satisfied automatically through the association of fields in other components of the database.

### CROSS-REFERENCE TO RELATED APPLICATIONS

This Nonprovisional Utility Patent Application claims the benefit of a previously filed provisional patent under 35 USC 199(e), the application number of which is 61/502,486.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The present invention relates to a computer method and system for purchasing construction lien and notice documents from calculated deadlines, and for smart recognition of a deadline's satisfaction, all over the Internet, a communication network, web widget, or mobile application.

Mechanics Liens:

Those furnishing labor, materials and/or services to private, state and federal construction projects around the United States have possible “mechanic's lien” claims in the event they are unpaid for their contribution. Popularly referred to as a “mechanic's lien,” the legal remedy is also called a “claim of lien,” “materialmen's lien,” “property lien,” “contractor lien,” “construction lien,” “statement of claim and privilege,” “notice of claim of lien,” and “stop work order.” When the labor, materials or services are furnished to a construction project owned privately (non-governmental ownership), the lien is placed against the property itself. When the labor, materials or services are furnished to a state or federal construction project, a lien against the government owned property is typically not available, but instead a “lien” is made against a bond under the federal Miller Act or each individual state's “Little Miller Act.” This lien remedy, which goes by many names and has different characteristics depending on the construction project's type, is referred to herein collectively as a “mechanic's lien.”

While the ability to file a mechanic's lien is uniformly available across the United States and its territories, the laws regulating its filing differs from state-to-state. In addition to each state having unique mechanic's lien laws, within these laws different treatment is afforded to construction participants depending on their role in the project (i.e. original contractor, subcontractor, architect, supplier, equipment lessor, etc), their tier in the project (i.e. their place in the contractual chain starting from the property owner or public entity commissioning work) and the type of construction project where services are furnished (i.e. commercial, residential, owner-occupied residential, industrial, oil & gas, state, federal, etc.).

To preserve one's right to file a mechanics lien, many states require project participants to meet pre-lien statutory notice requirements. In some states, notices are required before services are provided, and in others notices are required within a certain period before the lien is filed. In other states, notices are not required at all. These notices must meet statutory requirements, and must be sent according to the state's statutory service or delivery standards.

The act of filing a mechanics lien is also subject to varied legal requirements, with each state setting forth specific elements required within a mechanic's lien. After a lien is filed, many states require the mechanic's lien be served upon certain parties through pre-defined methods.

Finally, the mechanic's lien is a temporary encumbrance on private property or a surety bond. The encumbrance lasts for a specific period of time as provided by each jurisdiction's statute, and the encumbrance expires at the end of this time period unless action is taken by the lien claimant. In some jurisdictions, the mechanic's lien claim may be “extended” through a supplemental filing. When unable to extend or further extend a lien, the mechanic's lien claim must be “foreclosed upon” by filing an action seeking foreclosure in a designated court of law.

Web Applications, Product Ordering Interfaces, Mobile Applications, Widgets, Communications Networks:

The World Wide Web (WWW) is a well-known network of computers, whereby users around the world can access information displayed within a web browser. Typically the user accesses certain web pages that are displayed to the user through the HTML (Hyper-Text Markup Language) protocol. The user calls and retrieves specific HTML pages by requesting the page through a known URL (Uniform Resource Locator) using HTTP (HyperText Transfer Protocol).

Using certain computer languages such as PHP, Javascript, and HTML, listed here illustratively only and as examples, it has become common for companies and individuals to write applications that run and operate through web browsers on the World Wide Web. These web applications are similar to software applications that are written to operate on a user's desktop, except that they run through web browsers on the web.

Typically, a user will visit a certain website and be required to login to their account. Once logged in, the user will have access to the web application and its features. A web application can be designed to appear on a web browser access via a personal computer, or on a “mobile browser,” which is a web browser optimized for viewing on a mobile device.

Although web applications viewing on a standard web browser may be viewed on a mobile device through a mobile web browser, mobile devices also have the ability to run native mobile applications. These applications are optimized to operate on a mobile device (such as an iPhone or iPad, or an Android OS device) with or without the use of an Internet connection. The user opens the application on his or her mobile device and is able to view, alter and interact with the application without the use of a browser.

Next, a Product Ordering Interface is an interface on the WWW that a user accesses through an HTTP request. Here, the user will find the ability to order certain products from the website, including, in the instance of this invention, mechanic's liens, bond claim forms, notices, lien cancellations, and similar products.

A popular Product Ordering Interface is the “shopping cart” model, whereby a purchaser selects an item from an electronic catalog, which is electronically added to the purchaser's “shopping cart”, and when the purchaser is done selecting items all the orders in the shopping cart are “checked out” when the purchaser provides its billing and/or payment information.

Another Product Ordering Interface that is also popular is the less-sophisticated form-based system, whereby the purchaser selects the product or service through an electronic catalog of services or products, and is then forwarded to an online form where information about the purchaser (including the billing and payment information) is gathered.

Finally, a “widget” is a term of art defined by Wikipedia as “a small application that can be installed and executed within a web page by an end user.” Or more further described therein as “a stand-alone application that can be embedded into third party sites by any user on a page where they have rights of authorship.” Other terms used to describe web widgets include: portlet, gadget, badge, module, webjit, capsule, snippet, mini and flake.

A widget may be installed on any web page, displaying content to the viewer, or offering a certain application or function to the viewer. When an application or function is offered, the widget runs a script stored on the originating server, such that the viewer is able to complete a function within the widget without the host-site storing the function's code and framework.

For the purposes of this Specification, all of these applications, interfaces and networks, together with other non-discussed offline software systems and electronic communications, are collectively referred to as the “System” or “Application.”

Deadline Calculators and Lien Deadline Information Databases:

For quite some time, individuals and companies have offered resources to help construction participants understand and calculate the timeframe available to them to file construction notices, liens and bond claims across the country.

Most of these resources have been in paper format, simply separating the lien laws and lien law charts by state, and providing readers with a table of contents to the data. Some paper resources are more sophisticated, allowing users to move cardboard forms within a cardboard capsule so that a particular state will display in a carved out window; when a state is selected, that state's lien laws (or a summary thereof) will be displayed. Still, however, the reader would have to decipher which laws apply to their particular station. Further, these lien law summaries are merely a compilation of the lien laws across the United States and its territories.

With the advent of computer software and the Internet, lien law resources have gotten a bit more usable.

Software users and web visitors have a few options where they can use computer databases to decode some of the lien law information. For instance, a user using one of these databases can select their state and be shown the general lien law in that state. In another instance, which is more specific, the user may use a software application to house detailed information about their construction project and the system will—after gathering all this project information—ask the user to provide generic work performance dates and/or answer pre-programmed questions about the project, and from all this information, display more specific database information about the construction project's applicable lien laws.

In addition to applications and database information systems that provide information about lien laws, there are a variety of generic date/deadline calculators in the marketplace. These calculators typically calculate a set number of days, months or years from a given date, and schedule notifications when the deadline approaches.

However, all of the generic deadline calculators and more specific database systems for construction liens are inefficient and distinguished from this invention in that: (i) They do not offer the user a solution to the deadline or requirement calculated; (ii) They are not smart enough to recognize when the deadlines or requirements have been satisfied; (iii) They do not offer the user any capability to manage the deadlines or requirements.

Summary of the Art: Construction Lien and Notices Services Law firms, attorneys, form companies, software companies, and legal document preparation companies offer services to contractors, suppliers, architects, engineers and other construction participants that aid them with filing construction lien and notices. Construction liens and notices are form-driven documents, meaning that when filed or delivered, they are simply forms filled-in with the applicable information. The form varies from state-to-state, and also varies depending on subject's project type, role on the project, and who the role of party who hired the subject. The differences in the forms depend on a large number of variables, which when spread across the country, creates a significant variety of form-types that can be used for all the different construction liens and notices that may be filed.

Many companies sell forms online or in paper format at retail locations, or over the Internet. The customer experience is that they search for the type of form they need (without a significant degree of help or instruction), buy the form, and fill it in with the applicable information. The forms are static, in that they are offered as packaged only.

Other companies, commonly known as legal document preparation companies or document automation companies, will collect information from the customer, and then fill-in the form for them. In the construction industry, and particularly with regard to construction liens and notices, it is also common for these companies to deliver or file the form after completion as part of the service.

Attorneys and law firms offer legal advice and the preparation of legal documents, which may include the preparation of legal forms.

Finally, some companies sell software that will generate forms for the customer using document automation technology.

These services and service providers are distinguished from this Invention in that, while these service providers may have use for this Invention, they do not have a method and system for placing orders for their services or generating documents from calculated deadlines and requirements, nor do they have the ability otherwise provide their customers with a system and method to manage the construction lien and notice deadlines and requirements for projects.

### BRIEF SUMMARY OF THE INVENTION

This invention provides a Method and System for Ordering Mechanic's Lien and Notice Documents over the internet, mobile applications, or mobile communications network utilizing database records managed by a backend Product Input System that relates products/services to states, user role, hired-by role, and project type. The invention calculates Notice and Lien requirements, determines the applicable related products, and suggests those products to the user to order. The order can be requested by the user via a specific action, i.e. a single mouse click. The system remembers information already inputted by the user and requests other required information based on the product type.

This invention renders the calculated deadlines smart and usable by allowing the user to satisfy the determined deadline by ordering a specific applicable product and/or service as suggested by the invention. Further, the system is able to determine when a deadline has been satisfied automatically through the association of fields in other components of the database.

### BRIEF DESCRIPTION OF THE SEVERAL VIEWS OF THE DRAWINGS

FIG. 1 shows the product input system with blanks in which the required information is to be entered.

FIG. 2 shows a visual outline of the logic and system functionality for the method and system to order and generate products to satisfy the lien or notice deadline.

FIG. 3 shows a visual outline of the logic and system functionality for the method and system to satisfy lien and notice deadlines with smart recognition of deadline satisfaction.

FIG. 4 shows the invention with a user interface for product ordering.

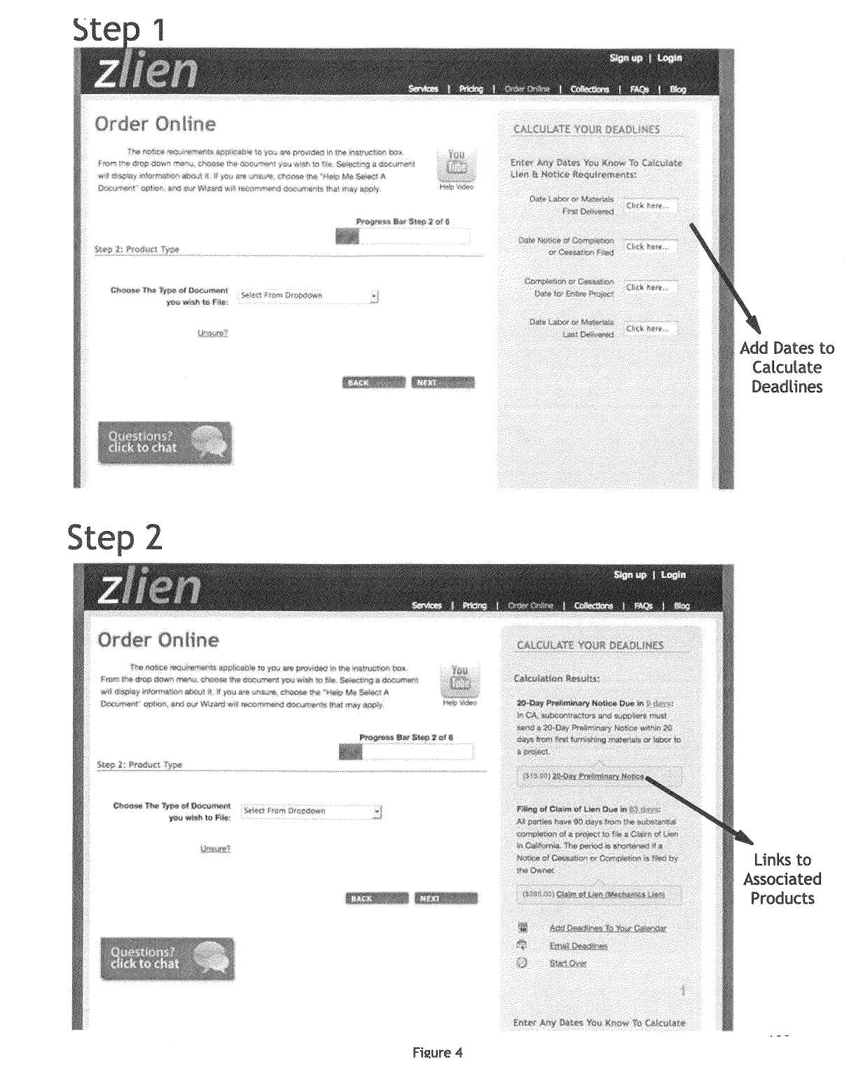

FIG. 5-1 shows the invention with a user interface in lien management system and displays where the user is requested to input dates.

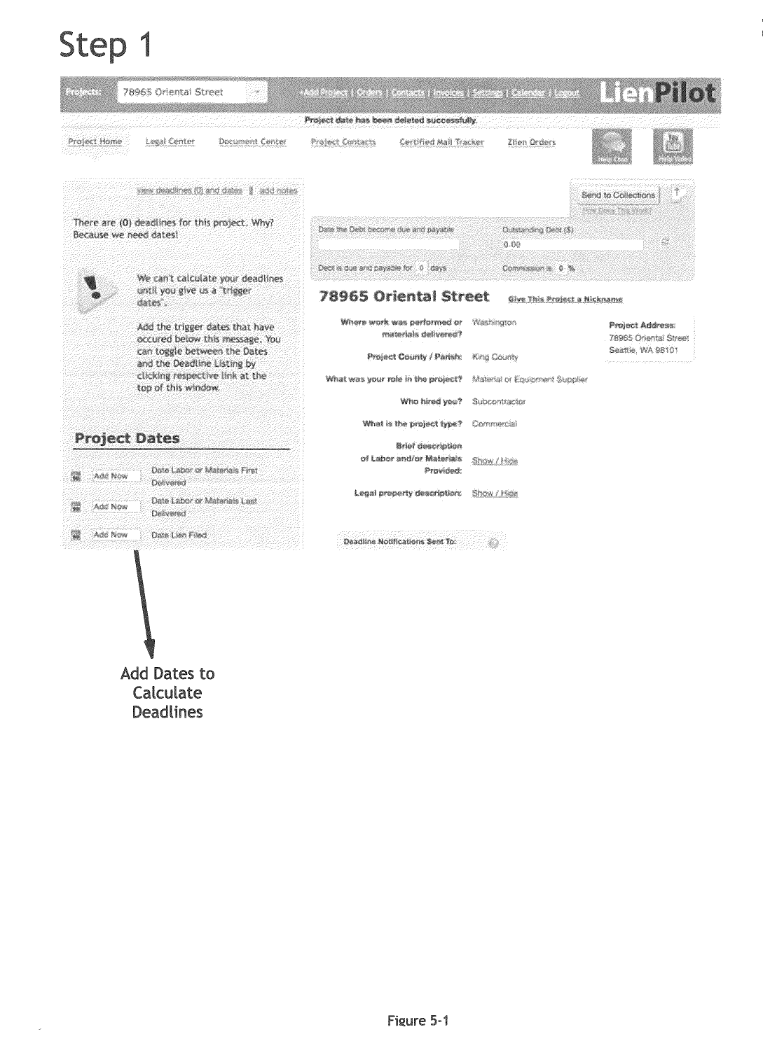

FIG. 5-2 shows the invention with a user interface in lien management system displaying products associated with determined deadlines for Order or Generation of applicable documents.

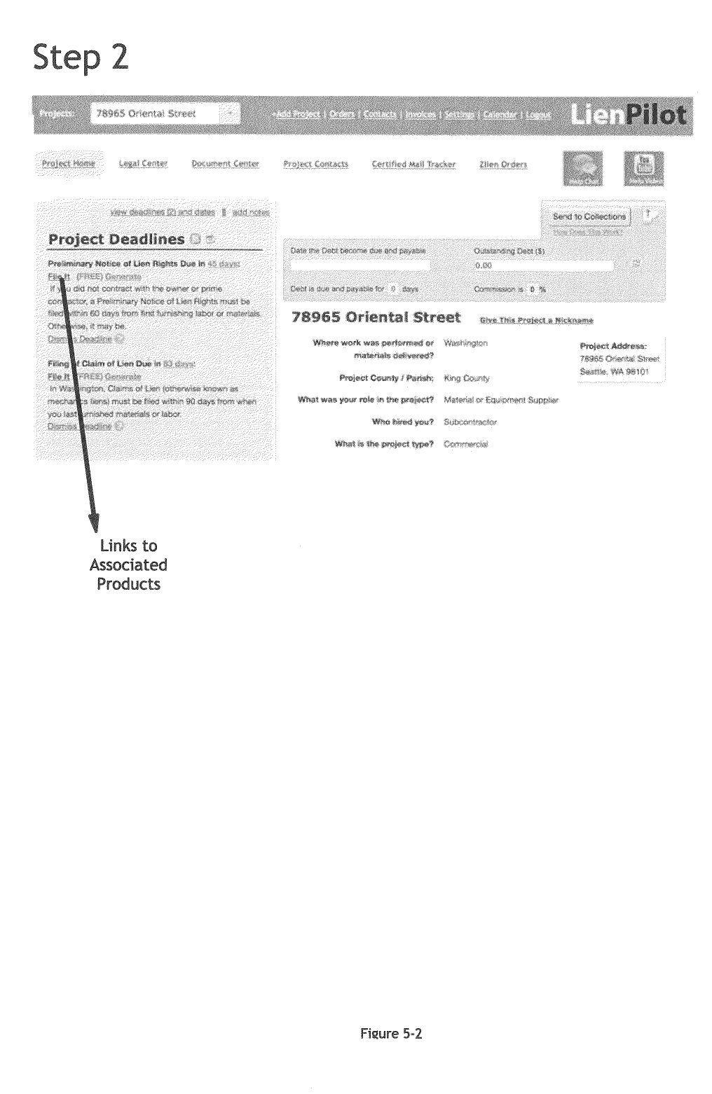

FIG. 5-3 shows the product ordering interface seen by the user after clicking “File” with identifier for all previously known information.

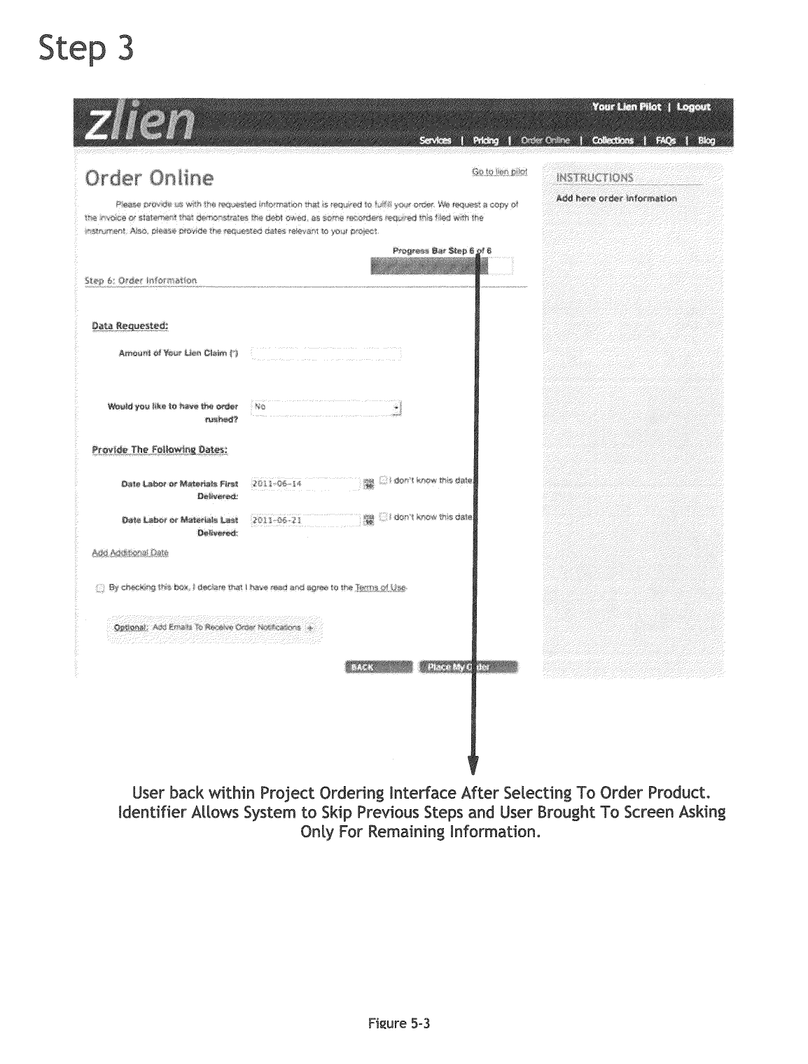

FIG. 6 shows a notification of deadline in electronic mail correspondence allowing user to use invention to satisfy the deadline by ordering or generating a product or service.

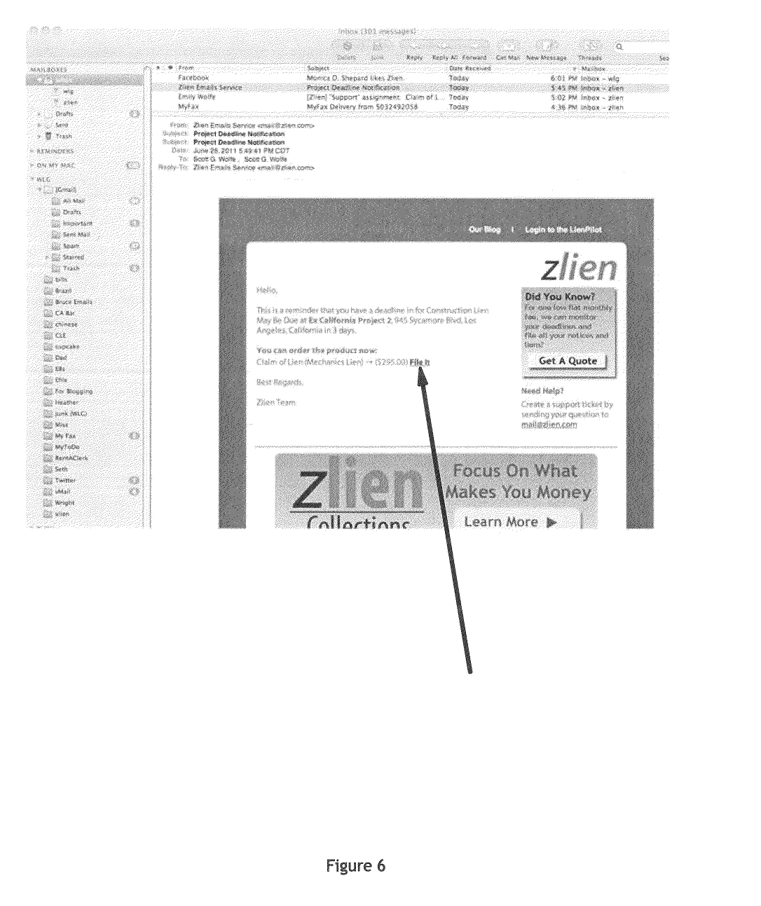

### DETAILED DESCRIPTION OF THE INVENTION

### A. Easy Ordering of Products/Services to Satisfy Construction Lien and Notice Deadlines

Whenever a construction lien or notice requirement is calculated by the System, the System will understand that certain products and services are applicable to the calculated requirement, and suggest those applicable products and services to the user for purchase.

The user viewing the calculated requirement may perform a specific action (i.e. single action such as a click of the mouse) to order the applicable product or service. The System will then move the user through the Product Ordering Interface to collect any remaining data required to complete the order of the product or service.

Any information already known about the client (i.e. the client's identifying information, the information input into any component of the system that lead to the requirement or deadline generation, identification of the construction project information, etc.) will be remembered by the System when the user performs the specific action, and the Product Ordering Interface will only request that the user provide unknown and required information, and possibly to confirm any existing information.

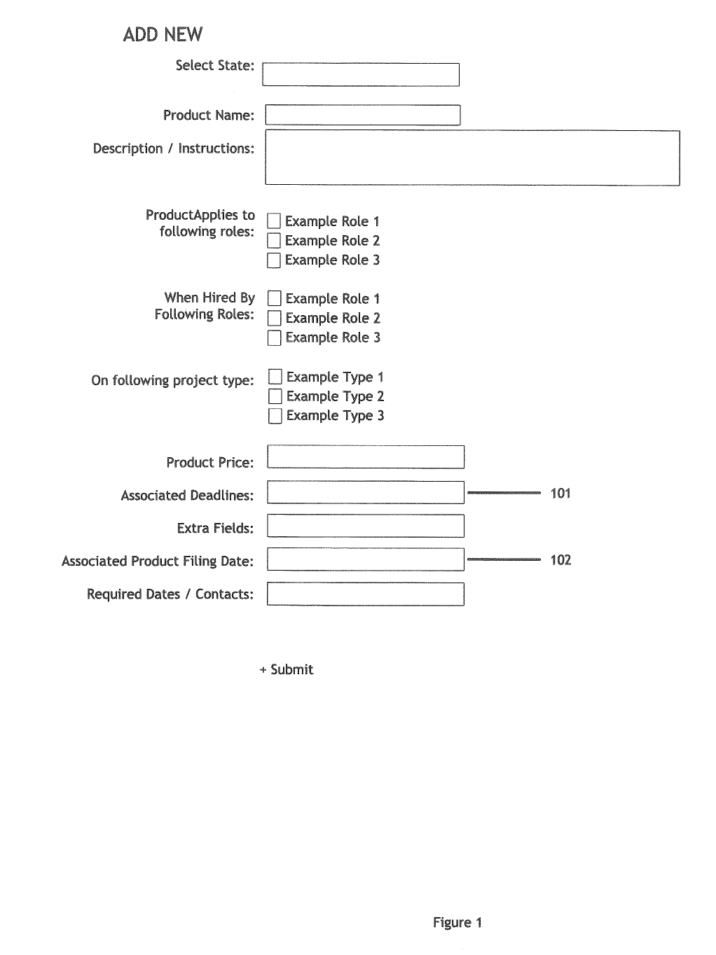

On the backend, the System has the following database structure, managed through an administration panel available to an administrator wherein s/he can add and edit applicable database records. Specifically, a backend Product Input System (FIG. 1) is built to allow administrators to create, modify and delete product/service records.

Products/Services are stored in the database with the following information (among other information, only the fields relevant to this filing is noted):

(1) Product/Service Name

(2) Associated State

(3) Associated Product Filing Date*

(4) Product Price

(5) Associated Contractor Roles

(6) Associated Hired By Role

(7) Associated Deadlines**

(8) Required Dates***

(9) Required Contacts***

(10) Extra Fields***

(11) Public Instructions

(12) Form Data****

*Relevance discussed below in description of smart recognition component of the invention.

** Only those deadlines that could be applicable to the project are displayed here and available for matching (i.e. the associated states match, along with the associated contractor roles, hired by roles, and project types).

*** Relevance discussed in Provisional Patent Application Number 61502483, EFS ID 10414631.

**** Relevance discussed below in description of generation of products/services based to satisfy construction lien and notice requirements.

Whenever a deadline or requirement is created by the System (using any method of calculating a construction lien or notice requirement, or when using system explained by Provisional Patent Application No. 61/499,609, EFS ID 10356444), the System understands that certain products and services are associated with the deadline calculated as indicated in the product/services database record's field for “Associated Deadlines.” (101)

The Products/Services that are associated with the deadline or requirement calculated by the System are displayed to the user. In displaying the associated products or services, the System displays: (i) The name of the product/service; (ii) The public instructions or description; (iii) The cost of the product service; (iv) An option to order the product/service, or as discussed below, the option to generate the product/service; and (v) If more than one product/service are associated, each are displayed for the user to choose.

Through a specific action (i.e. single mouse click), the user can communicate to the System requesting to order the Product/Services.

The System then analyzes all of the information currently known in relation to the user and the construction project being made subject of the requested Product/Service. This information—stored within the System—is kept as an “identifier” for that user and project, and the System then brings the user through the Product Ordering Interface requesting only that additional information required to complete the order for the Product/Service. This process, method and system for placing an order for a Construction Lien or Notice product or service is more specifically discussed in Provisional Patent Application No. 61/502,483, EFS ID 10414631.

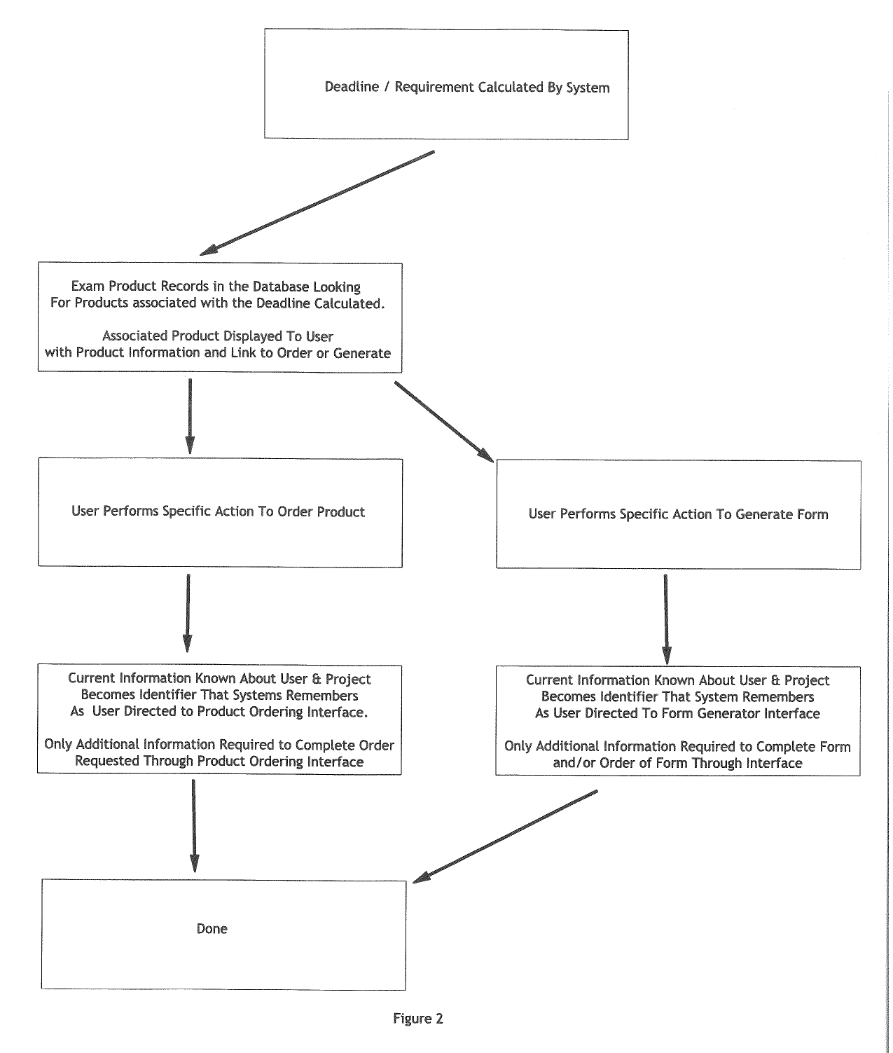

See FIG. 2.

### B. Generation of Documents to Satisfy Construction Lien and Notice Deadlines

This component of the system is similar to the description offered in the above-section A. The primary difference is that when the Product/Service is offered to the user for ordering, it is also offered to the user for generation.

The above-section A contemplates the user ordering a product or service (i.e. the construction lien or notice) that will be performed, furnished or fulfilled by the providing company. Unlike this type of fulfillment, this section B contemplates the user performing a specific action (i.e. single click of the mouse), and being led through a process whereby the product itself is generated through document automation technology.

As discussed in Section A, Products/Services are stored in the database with the following information (among other information, only the fields relevant to this filing is noted):

(1) Product/Service Name

(2) Associated State

(3) Associated Product Filing Date*

(4) Product Price

(5) Associated Contractor Roles

(6) Associated Hired By Role

(7) Associated Deadlines

(8) Required Dates

(9) Required Contacts

(10) Extra Fields***

(11) Public Instructions

(12) Form Data**

Of particular importance for this section is the (12) Form Data component. Stored with each product is form data, which saves the format of the product's particular form. The form's static components are saved with the proper font, size and margin settings, and where the form needs to be filled-in with dynamic data, placeholders referencing the data are inserted. When a form is generated, the data identified with the client, the project and the product request is merged with the form, replacing the placeholders with the dynamic data. This is standard document automation theory, and the particular feat of merging dynamic data with placeholders is not subject to this provisional patent application.

The Products/Services that are associated with the deadline or requirement calculated by the System are displayed to the user. In displaying the associated products or services, the System displays: (i) The name of the product/service; (ii) The public instructions or description; (iii) The cost of the product service; (iv) An option to order the product/service, or as discussed below, the option to generate the product/service; and (v) If more than one product/service are associated, each are displayed for the user to choose.

Through a specific action (i.e. single mouse click), the user can communicate to the System requesting to generate the Product/Services.

The System then analyzes all of the information currently known in relation to the user and the construction project being made subject of the requested Product/Service. This information—stored within the System—is kept as an “identifier” for that user and project, and the System then brings the user through the Product Ordering Interface requesting only that additional information required to complete the order for the Product/Service. This process, method and system for placing an order for a Construction Lien or Notice product or service is more specifically discussed in Provisional Patent Application No. 61/502,483, EFS ID 10414631.

The product is generated at this request, and depending on the user's privileges with the System is either (i) available to the user immediately to print, save to their local computer system, or export to a useable format such at .rtf, .doc, or .pdf; or (ii) available to the user after payment of a fee.

See FIG. 2.

### C. Smart Recognition of Deadline's Satisfaction

The big-picture of this Invention is that the deadlines calculated by the System through any logic or method, or through the method and system explained by Provisional Patent Application No. 61/499,609, EFS ID 10356444), are made smart and usable by offering the user the ability to satisfy the deadline with specific and applicable products and services, and by being managed automatically through the system's logic, method, database structure and system.

This section C discusses smart recognition of a deadline's satisfaction, which is an additional component to the big-picture method and system.

After a construction lien or notice deadline or requirement is calculated and displayed to the user, there must be a way for the System to satisfy the deadline or requirement.

Here are the various ways the System can mark the deadline as satisfied:
1) The user is offered an option to manually dismiss the deadline;
2) The user can close/archive/mark as complete the project, which satisfies any outstanding deadlines;
3) The System, through the association of fields in other components of the database, can know when a deadline is satisfied.

While Numbers 1 and 2 are self-explanatory by the discussion already contained herein, Number 3 requires further specification.

In addition to the fields enumerated in Sections A and B made part of the Product Input System, an additional field associated with each product is the “Product Filing Date.” (102). The Product Filing Date is a dropdown menu that displays all of the dates within the System database that could be associated with the Product (i.e. the State and Project Type of the Date Records match the State and Project Type of the Project Record).

The administrator selects the applicable date that should be entered after this Product/Service is completed.

For example, if someone orders the Mechanic's Lien product, the “Product Filing Date” for the Mechanic's Lien product would be the “Date Mechanic's Lien Filed.” When the Mechanic's Lien product order is completed (or the form is generated), the System affixes the completion or designated completion date as the “Product Filing Date.” In this example, the “Date Mechanic's Lien Filed” would be inputted as the completion or designated completion date for the Mechanic's Lien Product.

For additional clarification, if the mechanic's lien product is designated as complete on Jan. 1, 2011, then the Jan. 1, 2011 date will be affixed in the system and associated with the date record for “Date Mechanic's Lien Filed.” This is an automatic function of the System because it knows that the completion date for the product is =to the date for the affiliated Product Filing Date.

Because the System has in each Product/Service Record a “Product Filing Date” and “Associated Deadlines,” the System deduces that the Associated Deadline is satisfied whenever the “Product Filing Date” is accomplished. Therefore, whenever the “Product Filing Date” is entered by the user, either automatically through the placement of an order or generation of a form, or manually by inputting the date into the System, any Deadlines satisfied by that inputted Product Filing Date is marked satisfied within the System, and the user is no longer alerted to the impending requirement.

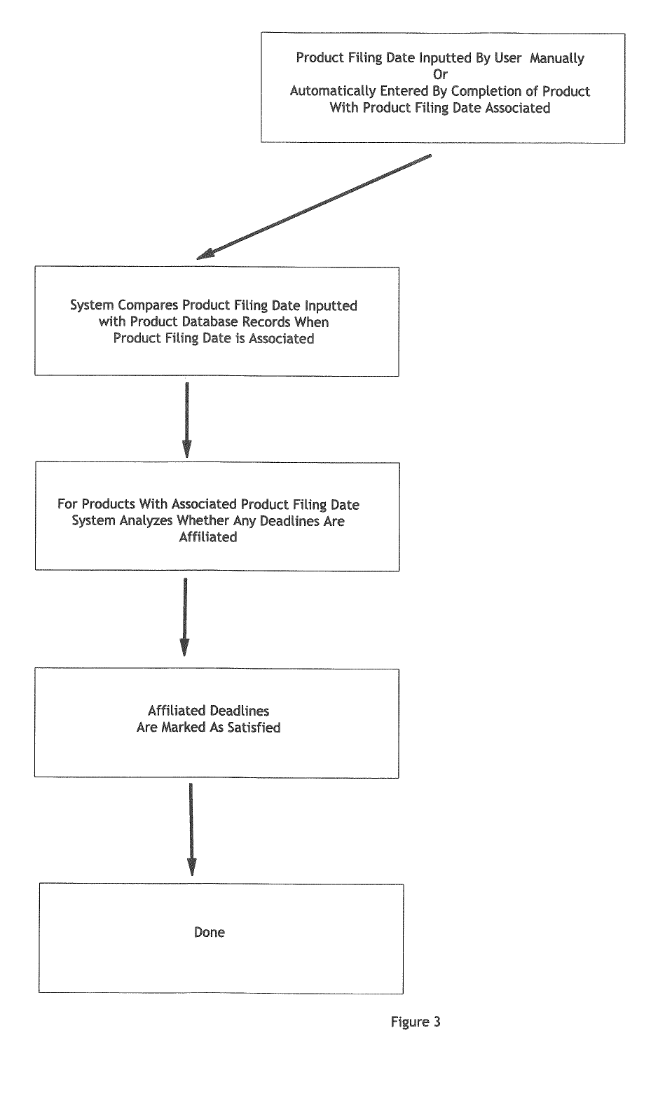

See FIG. 3.

1. A method of determining which mechanics lien, bond claim, miller act claim, lien claim, preliminary notice, notice to owner, construction notice, notice of intent to lien, pre-lien notice and related lien, claim, foreclosure and notice (all hereinafter collectively referred to as “Mechanics Lien”) document(s) can be used by a system user to satisfy the calculated Mechanics Lien requirement, by creating an association of applicable deadline records within each Mechanics Lien document record in the system's database (hereinafter the “Associated Deadline”).

2. A method of suggesting to the system user which Mechanics Lien document(s) to order, generate, download or otherwise acquire to satisfy the applicable Mechanics Lien requirement.

3. A method by which a system user performs a specific action, i.e. a single mouse click, to order, generate, download or otherwise acquire the Mechanics Lien document(s) suggested by the system through claim 2, whereby:
(i) The system user is shown which Mechanics Lien document(s) will satisfy an applicable Mechanics Lien requirement;
(ii) Through a hyperlink displayed to the user, the user can make a single click and request for ordering, generating, downloading or otherwise acquiring the applicable Mechanics Lien document;
(iii) Thereafter, the system will examine the database record for the associated system user and the project subject to the request enumerated in the above provision (ii) to survey which information is already present in that database and compare it to the information required for completion of the requested Mechanics Lien document, said information being associated with the Mechanics Lien Document pursuant to the claims made and described in patent application Ser. No. 13/490,749.
(iv) Thereafter, the system will request from the system user only the information required by the Mechanics Lien document as described patent application Ser. No. 13/490,749, but excluding any information the database already knows as determined in the comparison of existing database records and required database records contemplated in the above provision (iii).

4. A method by which a system user performs the function of claim Number 3 through the making of a sound;

5. A method by which a system user performs the function of claim Number 3 through the making of a motion on a screen or device;

6. A method by which Mechanics Lien requirements are understood to be dismissed, accomplished or otherwise satisfied by the system without any additional information from the system user, such that the system automatically understands a requirements' satisfaction through the association of fields in other components of the database, By:
(i) Having a database field associated with each Mechanics Lien document record identified as the “Product Filing Date,” whereby the system administrator can associate a date record (said date records displayed and associated with the Mechanics Lien document as described in patent application Ser. No. 13/490,645) with the Mechanics Lien document that is considered by the system as the “filing date” for that specific Mechanics Lien document;
(ii) Referring to the database record for the applicable Mechanics Lien document to compare that record's Product Filing Date (explained in this claim's above provision (i)) and it's Associated Deadline (explained in claim No. 1), and making a system presumption that the Associated Deadline is dismissed, accomplished or otherwise satisfied by the inputting into the database of the “Product Filing Date;”
(iii) Allowing the inputting of the “Product Filing Date” into the system by the user or administrator manually or by recording into the database the date that the user or administrator, as the case may be, completes the ordering, generating, downloading or acquiring of the applicable Mechanics Lien document as said Product Filing Date; and
(iv) Querying the system's deadline calculation function immediately upon the inputting of any such date to have the system calculate the Mechanics Lien requirement(s) for the specific project and display the same, indicating the deadline is satisfied if the case may be so, and also a method of querying the database in regular intervals to accomplish the same.
